(19) United States
(12) Patent Application Publication
(10) Pub. No.: US 2023/0236159 A1
(43) Pub. Date: Jul. 27, 2023

(54) Chromatograph Mass Spectrometry Data Processing Method, Chromatograph Mass Spectrometer, and Chromatograph Mass Spectrometry Data Processing Program

(71) Applicant: SHIMADZU CORPORATION, Kyoto-shi, Kyoto (JP)

(72) Inventor: Kiriko MATSUO, Kyoto-shi, Kyoto (JP)

(73) Assignee: SHIMADZU CORPORATION, Kyoto-shi, Kyoto (JP)

(21) Appl. No.: 17/926,319

(22) PCT Filed: May 25, 2020
(86) PCT No.: PCT/JP2020/020569

§ 371 Date: Nov. 18, 2022

(51) Int. Cl. G01N 30/86; G01N 30/72

(52) U.S. Cl. CPC G01N 30/8675; G01N 30/8631; G01N 30/72

(57) ABSTRACT

A chromatograph mass spectrometer includes a measurement unit including a mass spectrometry unit capable of MSⁿ analysis, and to separate sample components and repeatedly perform mass spectrometry, a chromatogram display processing unit to create a chromatogram at a specific m/z and display it, a time designation unit to designate a retention time according to a user operation, a spectrum display processing unit to create an MS spectrum corresponding to the retention time and an MSⁿ spectrum, as an MSⁿ analysis result corresponding to the retention time, targeting an m/z of a peak in the MS spectrum or an m/z range including the m/z, and display the MS spectrum and the MSⁿ spectrum on the same screen, the time designation section designating a retention time by a user moving a pointer, and the spectrum display processing unit, updating the display corresponding to the retention time corresponding to the pointer position.

### TECHNICAL FIELD

The present invention relates to a chromatograph mass spectrometer such as a liquid chromatograph mass spectrometer or a gas chromatograph mass spectrometer, a method of processing data obtained by chromatograph mass spectrometry, and a computer program for chromatograph mass spectrometry data processing.

### BACKGROUND ART

For qualitative and quantitative determination of a plurality of components (compounds) contained in a sample, a liquid chromatograph mass spectrometer (LC-MS) and a gas chromatograph mass spectrometer (GC-MS) are widely used. In these devices, mass spectrometry is repeatedly performed on a sample containing various components temporally separated by the chromatograph of a preceding stage by a mass spectrometry unit of a subsequent stage, and for example, mass spectra over a predetermined mass-to-charge ratio (m/z) range are acquired. Furthermore, on the basis of the result of the repeated mass spectrometry, a total ion chromatogram indicating change in time of the total contents of all the components and an extracted ion chromatogram (also referred to as mass chromatogram) indicating the time change of the signal intensity of ions having a specific mass-to-charge ratio are obtained.

When a user analyzes an analysis result obtained by the above device or observes the analysis result, it is necessary to appropriately display a chromatogram or a mass spectrum on a display screen so that the user can look into a waveform in the vicinity of a target location (a specific time, a specific mass-to-charge ratio, or the like) in detail or compare plurality of waveform shapes. Patent Literature 1 discloses a device that performs display for the purpose of efficiently performing such work. In this device, when a user designates a certain retention time of interest on a total ion chromatogram displayed on a screen by clicking or the like, the mass spectrum at the retention time is displayed. As a result, the user can easily grasp a chromatography peak and the mass spectrum corresponding to the chromatography peak by a simple operation.

CITATION LIST

### Patent Literature

Patent Literature 1: JP 2014-219317 A

Patent Literature 2: WO 2019/012589 A

Patent Literature 3: U.S. 8,809,770 B

### SUMMARY OF INVENTION

### Technical Problem

In recent years, LC-MS or GC-MS using a tandem mass spectrometer as a detector have been used as fields where qualitative and quantitative analysis of multiple specimens and multiple components is required, such as residual pesticide inspection in food or contaminant inspection in environmental water. In particular, a quadrupole-time-of-flight mass spectrometer (Q-TOF mass spectrometer) using a time-of-flight mass separator as a mass separator at the subsequent stage is capable of measuring with higher mass accuracy and mass resolution than a general triple quadrupole mass spectrometer, and thus it is efficiently used in identifying and quantifying components in a complicated sample,

In such LC-MS and GC-MS, various analysis methods such as data dependent analysis (DDA: Data Dependent Analysis or Data Dependent Acquisition) and data independent analysis (DIA: Data Independent Analysis or Data Independent Acquisition) are used (See Patent Literatures 2, 3, etc.).

In the DDA, a mass spectrum (MS spectrum) is first acquired by normal mass spectrometry (MS analysis), and then MS/MS analysis is performed using ions having a specific mass-to-charge ratio selected on the basis of the intensity or the like of a peak observed in the MS spectrum as precursor ions. Resultantly an MS/MS spectrum in which various product ions are observed. When there is no peak in the DDA satisfying an appropriate condition in the MS spectrum, the MS/MS analysis is not performed. On the other hand, the DIA is a method in which a mass-to-charge ratio range to be measured is divided into a plurality of parts, and a mass window is set for each part. Ions having a mass-to-charge ratio included in each mass window are collectively set as precursor ions, and product ions generated from the precursor ions are comprehensively scanned and measured to obtain MS/MS spectra for each mass window.

As described above, in the LC-MS or the GC-MS using the tandem mass spectrometer as a detector, a relationship between the MS spectrum and the MS/MS spectrum acquired by the analysis method to be used is complicated, and a troublesome and complicated operation is required for the user to grasp the relationship.

The present invention has been made in view of such problems, and a main object of the present invention is to enable a user to easily grasp a relationship between an acquired MS spectrum and an MSⁿ spectrum in a chromatograph mass spectrometer in which MS/MS analysis is automatically executed according to predetermined settings and conditions.

Solution To Problem

One mole of a chromatograph mass spectrometry data processing method according to the present invention made to solve the above problems is a chromatograph mass spectrometry data processing method for processing data collected by a measurement unit including a mass spectrometry Unit capable of MSⁿ analysis (n is an integer of 2 or more), and configured to temporally separate components in a sample by a chromatograph, and repeatedly perform mass spectrometry on the separated sample, the chromatograph mass spectrometry data processing method including:
a chromatogram display processing step of creating a chromatogram at a specific mass-to-charge ratio based on the data collected by the measurement unit and displaying the chromatogram on a screen of a display unit;
a time designation step of designating a retention time according to an operation of a user on the displayed chromatogram; and
a spectrum display processing step of creating an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which die mass-to-charge ratio belongs are precursor ions, based on the data collected by the measurement unit, and displaying the MS spectrum and the MSⁿ spectrum on a same screen with the chromatogram,
wherein in the time designation step, the retention time is designated by an operation of moving a pointer displayed on the chromatogram, and
in the spectrum display processing step, as the pointer is moved, display of the MS spectrum and the MSⁿ spectrum is updated corresponding to each retention time during the movement of the pointer.

One mode of a chromatograph mass spectrometer according to the present invention made to solve the above problems includes:
a measurement unit including a mass spectrometry unit capable of MSⁿ analysis (n is an integer of 2 or more), and configured to temporally separate components in a sample by a chromatograph and repeatedly perform mass spectrometry on the separated sample;
a chromatogram display processing unit configured to create a chromatogram at a specific mass-to-charge ratio based on data collected by the measurement unit and display the chromatogram on a screen of a display unit;
a time designation unit configured to designate a retention time according to an operation of a user on the displayed chromatogram, and
a spectrum display processing unit configured to create an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and display the MS spectrum and the MSⁿ spectrum on a same screen with the chromatogram,
wherein the time designation unit is configured to designate a retention time by allowing a user to perform an operation to move a pointer displayed on the chromatogram, and
the spectrum display processing unit is configured to, as the pointer is moved, update display of the MS spectrum and the MSⁿ spectrum corresponding to each retention time during movement of the pointer.

One mode of a chromatograph mass spectrometry data processing program according to the present invention made to solve the above problems is a chromatograph mass spectrometry data processing program that, using a computer, processes data collected by a measurement unit including a mass spectrometry unit capable of MSⁿ analysis (n is an integer of 2 or more), and configured to temporally separate components in a sample by a chromatograph and repeatedly perform mass spectrometry on the separated sample, the program causing the computer to operate as:
a chromatogram display processing function unit configured to create a chromatogram at a specific mass-to-charge ratio based on the data collected by the measurement unit and display the chromatogram on a screen of a display unit;
a time designation function unit configured to designate a retention time according to an operation of a user on the displayed chromatogram; and
a spectrum display processing function unit configured to create an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and display the MS spectrum and the MSⁿ spectrum on a same screen with the chromatogram,
wherein the time designation function unit is configured to design a retention time by an operation of moving a pointer displayed on the chromatogram, and
the spectrum display processing function unit is configured to, as the pointer is moved, update display of the MS spectrum and the MSⁿ spectrum corresponding to each retention time during movement of the pointer.

Here, the chromatograph is a liquid chromatograph or a gas chromatograph.

The chromatograph mass spectrometry data processing program according to the present invention can be stored in a non-transitory computer-readable recording medium such as a CD-ROM, a DVD-ROM, a memory card, or a USB memory (dongle) and provided to the user. Alternatively, the information can be provided to the user the form of data transfer via a communication line such as the Internet. Of course, in a case where the user newly purchases a system, the data processing program can be installed in advance in a computer included in the system.

### Advantageous Effects of Invention

In one mode of the chromatograph mass spectrometry data processing method, the chromatograph mass spectrometer, and the chromatograph mass spectrometry data processing program according to the present invention, a user designates a retention time of interest by a predetermined operation on a chromatogram at a specific mass-to-Charge ratio, that is, an extracted ion chromatogram, displayed on a display screen. Then, an MS spectrum corresponding to the designated retention time, that is, an MS spectrum based on data acquired at the retention time, and an MSⁿ spectrum corresponding to the retention time, that is, an MSⁿ spectrum observed in the MS spectrum and with ions having a mass-to-charge ratio of the extracted ion chromatogram as precursor ions, are displayed on the same screen as the extracted ion chromatogram. Thereby, the user can visually and easily grasp a relationship between the MS spectrum and the MS/MS spectrum for each retention time. Furthermore, for example, a temporal change of the MS spectrum and the MSⁿ spectrum in the vicinity of the retention time of interest, such as a retention time corresponding to a peak top on the extracted ion chromatogram, can be observed on the screen. Thereby, the collected data can be analyzed in a more multifaceted manner, and useful and accurate information can be extracted for the identification and quantification of the compound.

In one mode of the chromatograph mass spectrometry data processing method, the chromatograph mass spectrometer, and the chromatograph mass spectrometry data processing program according to the present invention, when the user changes the designation of the retention time, for example, by performing an operation of moving a pointer displayed on the extracted ion chromatogram, the MS spectrum and the MSⁿ spectrum corresponding to each retention time during the movement are sequentially displayed with the movement of the pointer. Therefore, the user can observe the MS spectrum and the MS/MS spectrum during and after the movement of the pointer in substantially real time. Thereby, both the temporal change of the MS spectrum and the temporal change of the MS/MS spectrum for a specific precursor ion in a parent-child relationship with the MS spectrum can be simultaneously visually and quickly grasped, and for example, the retention time in which the temporal change of the MS spectrum and the MS/MS spectrum its the parent-child relationship is characteristic or noteworthy can be easily and efficiently found.

### BRIEF DESCRIPTION OF DRAWINGS

FIG. 1 is a schematic configuration diagram of an LC-MS analysis system according to an embodiment of the present invention.

FIG. 2 is a schematic diagram for explaining DDA analysis in the LC-MS analysis system of the present embodiment.

FIG. 3 is a schematic diagram for explaining DIA analysis in the LC-MS analysis system of the present embodiment.

FIG. 4 is a schematic diagram for explaining the DIA analysis in the LC-MS analysis system of the present embodiment.

FIG. 5 is a diagram illustrating an example of a display screen in the LC-MS analysis system of the present embodiment.

FIG. 6 is an explanatory diagram of spectrum, processing in the LC-MS analysis system of the present embodiment.

### DESCRIPTION OF EMBODIMENTS

Hereinafter, an LC-MS analysis system which is an embodiment of a chromatograph mass spectrometer according to the present invention will be described with reference to the accompanying drawings.

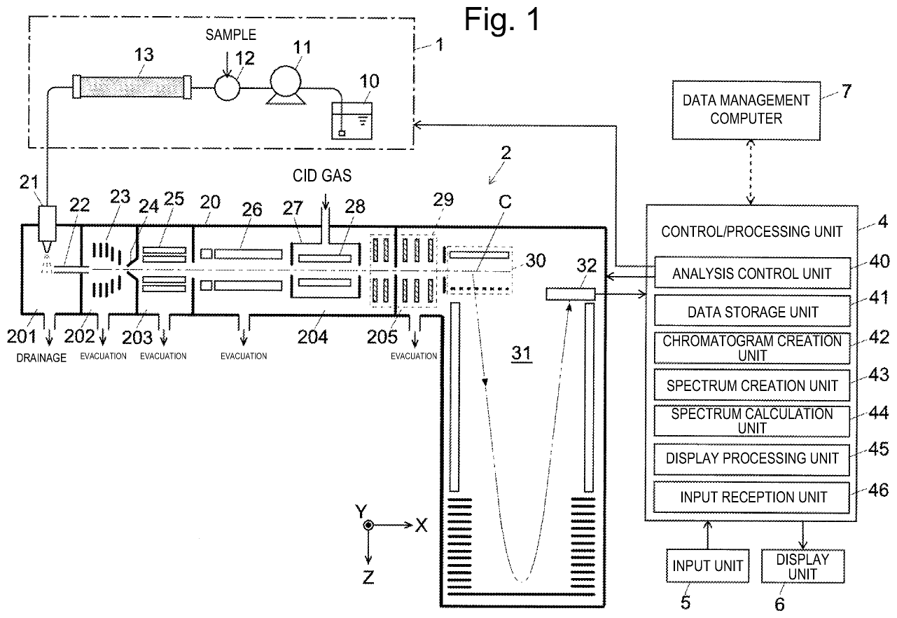

FIG. 1 is a schematic configuration diagram of the LC-MS analysis system of the present embodiment.

As illustrated in FIG. 1, the LC-MS analysis system includes a measurement unit including a liquid chromatograph unit 1 and a mass spectrometry unit 2, a control/processing unit 4, an input unit 5, and a display unit 6. The data management computer 7 illustrated in FIG. 1 is basically a component unnecessary for the present system, but can also be included in the present system as described later.

The liquid chromatograph unit 1 includes a mobile phase container 10 in which a mobile phase is stored, a liquid feeding pump 11 that sucks the mobile phase and delivers the mobile phase at a substantially constant flow rate, an injector 12 that supplies a sample liquid into the mobile phase, and a column 13 that temporally separates various components contained in the sample liquid.

The mass spectrometry unit 2 is a quadrupole-time-of-flight (Q-TOF) mass spectrometer, and includes an ionization chamber 201 with a substantially atmospheric pressure atmosphere and a vacuum chamber 20 whose inside is divided into four. In the vacuum chamber 20, a first intermediate vacuum chamber 202, a second intermediate vacuum chamber 203, a first high vacuum chamber 204, and a second high vacuum chamber 205 are provided, and each chamber is evacuated by a vacuum pump so that a degree of vacuum increases in this order. That is, the mass spectrometry unit 2 adopts a configuration of a multi-stage differential exhaust system.

An electrospray ionization (ESI) probe 21 to which an eluate is supplied from an outlet of the column 13 is disposed in the ionization chamber 201, and the ionization chamber 201 and the first intermediate vacuum chamber 202 communicate with each other through a desolvation tube 22 having a small diameter. The first intermediate vacuum chamber 202 and the second intermediate vacuum chamber 203 communicate with each other through an orifice formed at a top of a skimmer 24, and ion guides 23 and 25 are disposed in the first intermediate vacuum chamber 202 and the second intermediate vacuum Chamber 203, respectively. In the first high vacuum chamber 204, a quadrupole mass filter 26 and a collision cell 27 in which an ion guide 28 is disposed are provided. A plurality of electrodes arranged across the first high vacuum chamber 204 and the second high vacuum chamber 205 constitute an ion guide 29. Further, in the second high vacuum chamber 205, a time-of-flight mass separator of an orthogonal acceleration system including an orthogonal acceleration unit 30 and an ion flight unit 31 having a reflection, and an ion detector 32 are provided.

The control/processing unit 4 includes, as functional blocks, an analysis control unit 40, a data storage unit 41, a chromatogram creation unit 42, a spectrum creation unit 43, a spectrum calculation unit 44, a display processing unit 45, and an input reception unit 46.

In general, the entity of the control/processing unit 4 is a personal computer, a workstation, or the like, and each functional block described above can be embodied by executing one or a plurality of dedicated software (computer programs) installed in such a computer in the computer. Such a computer program can be stored in a non-transitory computer-readable recording medium such as a CD-ROM, a DVD-ROM, a memory card, or a USB memory (dongle) and provided to the user. Alternatively, the information can be provided to the user in the form of data transfer via a communication line such as the Internet. Alternatively, the system can be pre-installed on a computer that is a part of the system when the user purchases the system.

The analysis control unit 40 controls the measurement unit to perform LC/MS analysis on the prepared sample. Next, a typical measurement operation executed under the control of the analysis control unit 40 will be schematically described. In this LC-MS analysis system, it is possible to selectively perform normal mass spectrometry (MS analysis) without ion dissociation and MS/MS (=MS²) analysis in which ions are dissociated by, collision-induced dissociation (CID).

In the liquid chromatograph unit 1, the liquid feeding pump 11 sucks the mobile phase from the mobile phase container 10 and feeds the mobile phase to the column 13 at a substantially constant flow rate. In response to an instruction from the analysis control unit 40, the injector 12 supplies the sample into the mobile phase. The sample is carried on the mobile phase and introduced into the column 13, and the components in the sample are temporally separated while passing through the column 13. The eluate from an outlet of the column 13 is introduced into the ESI probe 21, and the ESI probe 21 nebulizes the eluate into the ionization chamber 201 as charged droplets. In a process in which the charged droplets are refined and the solvent in the droplets is vaporized, the sample component in the droplets becomes a gas ion.

The generated ions are sent into the first intermediate vacuum chamber 202 through the desolvation tube 22, sequentially pass through the ion guide 23, the skimmer 24, and the ion guide 25, and are introduced into the quadrupole mass filter 26 in the first high vacuum chamber 204. In the case of the MS analysis, ions are transported almost without passing through the quadrupole mass filter 26 and the collision cell 27 to the orthogonal acceleration unit 30. On the other hand, in the case of the MS/MS analysis a predetermined voltage is applied to each of a plurality of rod electrodes constituting the quadrupole mass filter 26, and an ion species haying a specific mass-to-charge ratio according to the voltage or an ion species included in a specific mass-to-charge ratio range according to the voltage is selected as a precursor ion and passes through the quadrupole mass filter 26. A collision gas such as Ar gas is introduced into the collision cell 27, and the precursor ions come into contact with the collision gas and are dissociated by the CID to generate various product ions. The generated product ions are transported to orthogonal acceleration unit 30 via the ion guide 29.

Depending on kinetic energy (collision energy) of the ions when the precursor ions are incident on the collision cell 27, a mode of dissociation of the ions is different. Therefore, even if the precursor ions are the same, the type of product ions to be generated can be changed by appropriately adjusting the collision energy. Not all the precursor ions can be dissociated, but some of the precursor ions can be left without being dissociated. As is well known, generally, the collision energy is determined by a voltage difference between a DC bias voltage applied to the quadrupole mass filter 26 and a DC voltage applied to a lens electrode disposed at an ion inlet of the collision cell 27.

In the orthogonal acceleration unit 30, ions are accelerated substantially simultaneously in a direction (Z-axis direction) substantially orthogonal to an incident direction (X-axis direction). The accelerated ions fly at a speed corresponding to the mass-to-charge ratio, turn back and fly as indicated by a two-dot chain line in FIG. 1 in the ion flight unit 31, and reach the ion detector 32. Various ions substantially simultaneously started from the orthogonal acceleration unit 30 reach the ion detector 32 in ascending order of mass-to-charge ratio and are detected, and the ion detector 32 outputs a detection signal (ionic intensity signal) corresponding to the number of ions to the control/processing unit 4.

In the control/processing unit 4, the data storage unit 41 digitizes the detection signal, and further converts the time of flight from a time point at which the ions are ejected from the orthogonal acceleration unit 30 into a mass to-charge ratio, thereby acquiring and storing mass spectrum data (profile data). The orthogonal acceleration unit 30 repeatedly ejects ions toward the ion that unit 31 at a predetermined cycle. As a result, the data storage unit 41 can repeatedly acquire mass spectrum data over a predetermined mass-to-charge ratio range at a predetermined cycle.

In the LC/MS analysis, it is often difficult to perform a plurality of measurements on one sample. Therefore, it is necessary to collect as much information as possible on a large number of components contained in the sample by one measurement (one sample supply). Correspondingly, in the LC-MS analysis system of the present embodiment, measurement in a plurality of analysis modes including the above-described DDA and DIA is possible.

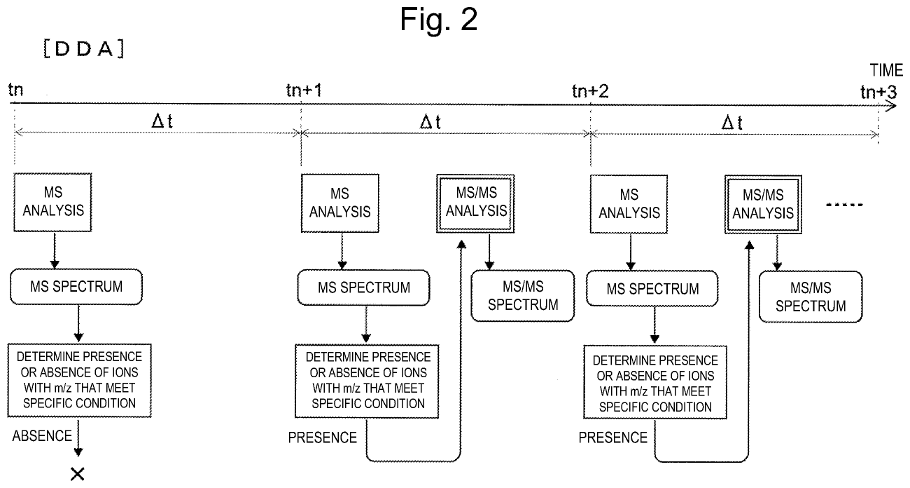

FIG. 2 is a schematic diagram illustrating a flow of analysis in the DDA mode. In the DDA, the MS analysis over a predetermined mass-to-charge ratio range is typically repeated at a constant period (time Δt interval in FIG. 2). The control/processing unit 4 creates an MS spectrum immediately every time the MS analysis is performed, and checks whether or not an ion peak observed in the MS spectrum meets a preset specific condition. Then, when there is a peak that meets the specific condition, the MS/MS analysis using ions having a mass-to-charge ratio corresponding to the peak as precursor ions is performed subsequently to the MS analysis. This makes it possible to acquire an MS/MS spectrum in which various product ions generated from the precursor ions are observed.

The specific condition can be, for example, a condition having the maximum ionic intensity. In the example illustrated in FIG. 2, only one MS/MS analysis is performed following the MS analysis. However, if there is a time margin, multiple MS/MS analyses for precursor ions different from each other can be performed following one MS analysis. In that case, for example, a predetermined number of peaks are selected in descending order of ionic intensity among peaks observed in the MS spectrum, and ions having a mass-to-charge ratio corresponding to the peaks can be used as precursor ions. As can also be seen from FIG. 2, in the DDA, an MS/MS spectrum corresponding to an MS spectrum obtained at a certain retention time does not necessarily exist.

In the DDA, MS spectrum data obtained by the MS analysis and MS/MS spectrum data obtained by the MS/MS analysis can be stored in different data files for each analysis. In that case, information such as a retention time (tn, tn+1, . . . ) of which the data is collected and a mass-to-charge ratio value of precursor ions (in the case of the MS/ MS spectra) is also recorded in each data file. The MS spectrum data and the MS/MS spectrum data acquired at the same retention time (tn, tn+1, . . . ) may be stored in the same data file.

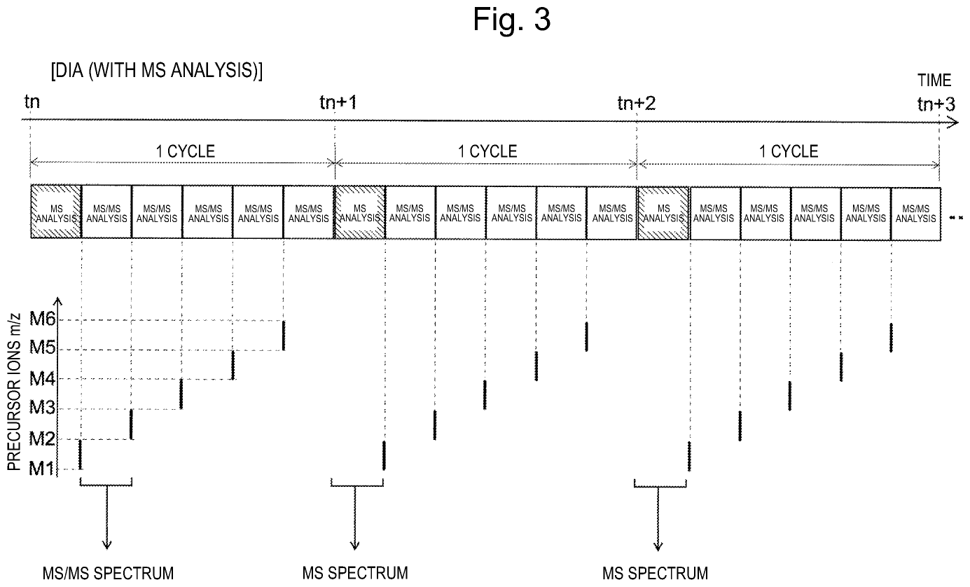

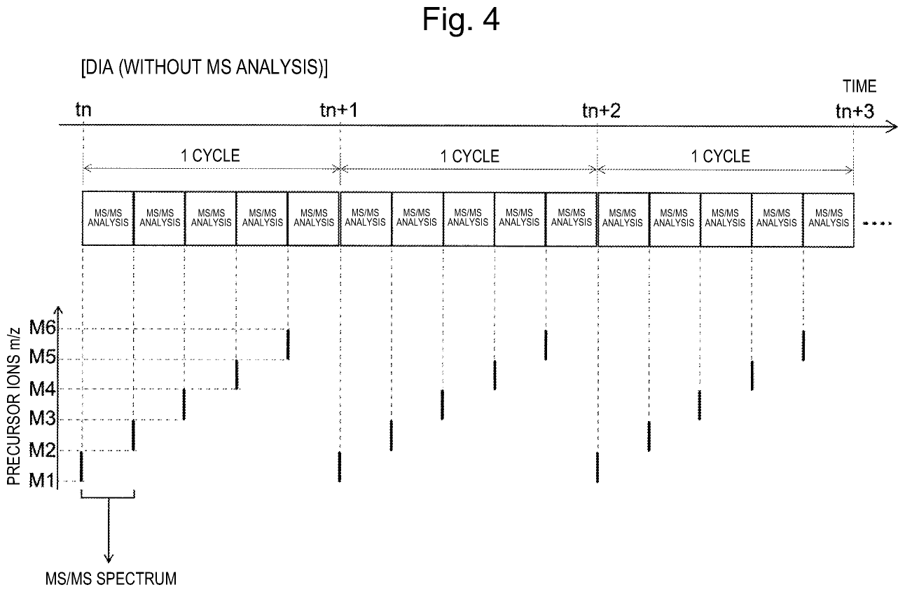

FIGS. 3 and 4 are schematic diagrams for explaining a flow of analysis in the DIA mode. FIG. 3 illustrates an example in which the MS analysis is periodically performed, and FIG. 4 illustrates an example in which the MS analysis is not performed.

In the DIA, the entire mass-to-charge ratio range to he measured is divided into a plurality of parts, mass windows are set for the respective parts, ions having mass-to-charge ratios included in the respective mass windows are collectively selected as precursor ions, and MS/MS analysis is performed.

In the examples of FIGS. 3 and 4, the mass-to-charge ratio ranges M1 to M6 are divided into five, and MS/MS analysis targeting ions having mass-to-charge ratios respectively included in the five mass windows is performed. Since one M/MS spectrum is obtained for each mass window, five MS/MS spectra are obtained in one cycle in the examples of FIGS. 3 and 4, and product ions derived from all components introduced into the mass spectrometry unit 2 at that time appear in the five MS/MS spectra. That is, comprehensive product ion information on all the components can be obtained. As described above, when the collision energy at the time of CID is adjusted, a peak of the precursor ion itself is also observed it the MS/MS spectrum. Therefore, when one MS/MS spectrum is created by adding or averaging a plurality of MS/MS spectra obtained during one cycle, it is possible to obtain information on product ions of all components to be measured or the product ions and precursor ions at the retention time.

Although MS analysis is not performed in the DIA illustrated in FIG. 4, it is possible to obtain an MS/MS spectrum in which a peak of the precursor ion itself is substantially observed by adjusting the collision energy as described above. In this case, since it is not necessary to perform the MS analysis, the time of one cycle can be shortened accordingly. On the other hand, in the DIA illustrated in FIG. 3, since the MS analysis over a predetermined mass-to-charge ratio range is performed once per cycle, an MS spectrum can be acquired separately from the MS/MS spectrum. Therefore, it is not necessary to acquire information on the precursor ions at the time of the MS/MS analysis, and for example, all the precursor ions may be dissociated by the CID at the time of the MS/MS analysis. Therefore, the signal intensity of product ion, in the MS/MS spectrum is increased, and the sensitivity can be improved.

FIGS. 3 and 4 are simplified diagrams for explanation, and in general, the number of mass windows is larger, and the mass-to-charge ratio width of one mass window is in a range of about 10 to 100 Da, for example, 20 Da.

In the DIA, similarly to the DDA, MS spectrum data obtained by the MS analysis and MS/MS spectrum data obtained by the MS/MS analysis can be stored in different data files for each analysis. MS spectrum data and a plurality of pieces of MS/MS spectrum data acquired at the same retention time (tn, tn+1, . . . ), or a plurality of pieces of MS/MS spectrum data may be stored in the same data file.

When the LC/MS analysis using the DDA car the DIA as described above is performed on one sample, a data file storing MS spectrum data and/or MS/MS spectrum data corresponding to the LC/MS analysis is stored in the data storage unit 41. Next, data processing mainly including display processing executed in the LC-MS analysis system of the present embodiment in a state where such data is stored will be described.

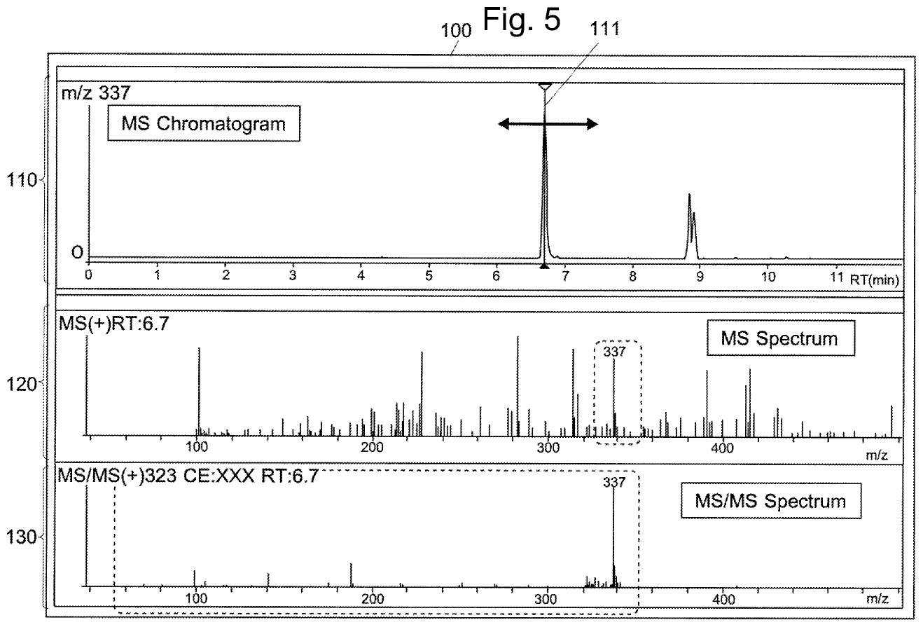

FIG. 5 is a diagram illustrating an example of a graph displayed on a screen of the display unit 6 in the LC-MS analysis system of the present embodiment. However, not only the one illustrated in FIG. 5 is displayed on the screen of the display unit 6, and this can be displayed together with another graph, table, or the like. That is, the display illustrated in FIG. 5 is a display of the entire screen or a part of the screen.

The user indicates a mass-to-charge ratio value of interest through the input unit 5. The compound name may be indicated instead of the mass-to-charge ratio value. When a compound to be observed whether it is contained in a sample or a compound to be quantified is determined, the compound or a mass-to-charge ratio value corresponding to the compound may be indicated. In a case where analysis processing such as identification and quantification based on the collected data is once finished, and it is desired to observe the result or perform reanalysis, for example, a list of identified compounds is displayed, and a compound of interest or a mass-to-charge ratio value corresponding to the compound can be indicated from the list. Alternatively, instead of the user indicating the compound or the mass-to-charge ratio value, for example, a compound or a mass-to-charge ratio value most suitable for a preset condition may be automatically selected and set. For example, a method is conceivable in which a compound having the largest content is automatically selected among compounds having a mass in a certain range on the basis of a quantitative analysis result.

When receiving the indication by the user or the automatic selection indication as described above through the input reception unit 46, the chromatogram creation unit 42 extracts a signal intensity corresponding to the indicated mass-to-charge ratio value at each retention time from the MS spectrum data stored in the data storage unit 41. Then, an extracted ion chromatogram at the mass-to-charge ratio value is created. The display processing unit 45 draws the created extracted ion chromatogram in a predetermined region on the screen of the display unit 6. In a graph display screen 100 illustrated in FIG. 5, an uppermost stage is a chromatogram display region 110, and the extracted ion chromatogram at the indicated m/z 337 is drawn in this region 110.

A pointer 111 including a vertical line is superimposed and displayed on the extracted ion chromatogram displayed in the chromatogram display region 110. The pointer 111 is movable on a time axis (on a horizontal axis in FIG. 5) according to a scrolling operation or the like with a pointing device such as a mouse, a keyboard, or the like included in the input unit 5 as shown by thick double-ended arrows in the drawing. The pointer 111 indicates one time (retention time) on the time axis, and the spectrum creation unit 43 creates an MS spectrum corresponding to the retention time at which the pointer 111 is located on the basis of the data stored in the data storage unit 41 The display processing unit 45 draws the created MS spectrum in a predetermined region on the screen of the display unit 6. In FIG. 5, a middle stage is an MS spectrum display region 120, and the MS spectrum at the retention time RT 6.7 min is drawn in this region 120.

Moreover, from the data stored in the data storage unit 41, the spectrum creation unit 43 searches for MS/MS spectrum data corresponding to the retention time (retention time RT 6.7 min in the example of FIG. 5) at which the pointer 111 is positioned and having precursor ions at a mass-to-charge ratio (m/z 337 in the example of FIG. 5) that is a target of the extracted ion chromatogram, that is, MS/MS spectrum data that has a parent-child relationship with the above MS spectrum, and creates an MS/MS spectrum do the basis of the data, if any. The display processing unit 45 draws the created MS/MS spectrum in a predetermined region on the screen of the display unit 6. In FIG. 5, a lower stage is an MS/MS spectrum display region 130, and an MS/MS spectrum having a retention time of RT 6.7 min and a precursor ion of m/z 337 is drawn in this region 130.

When analysis is performed in the DDA mode as illustrated in FIG. 2, MS/MS spectrum data in which a specified mass-to-charge ratio is used as precursor ions does not necessarily exist. Therefore, if the corresponding MS/MS spectrum data exists, the MS/MS spectrum is displayed, and if the corresponding MS/MS spectrum data does not exist, the MS/MS spectrum is not displayed, and for example, display indicating that there is no MS/MS spectrum is performed.

When analysis is performed in the DIA mode with the MS analysis as illustrated in FIG. 3, as described above, there is MS/MS spectrum data in which all ions included, in a predetermined mass-to-charge ratio range are precursor ions for each cycle. Therefore, MS/MS spectrum data corresponding to the mass window including the mass-to-charge ratio (m/z 337 in the example of FIG. 5) as the target can be extracted, and the MS/MS spectrum can be created and displayed.

On the other hand, when analysis is performed in the DIA mode without the MS analysis as illustrated in FIG. 4, MS/MS spectrum data is present, but MS spectrum data is not present. Therefore, in this case, one of the following two methods can be adopted.

The first method is a method in which an MS spectrum is not displayed, only an MS/MS spectrum corresponding to a mass window containing a mass-to-charge ratio that is a target of an extracted ion chromatogram is displayed, and the MS spectrum is not displayed.

The second method is a method of creating a pseudo MS spectrum using MS/MS spectra corresponding to a plurality of mass windows obtained at the same retention time, and displaying the pseudo MS spectrum in the MS spectrum display region 120.

As described above, usually, in the DIA mode without the MS analysis, a collision energy is appropriately adjusted during the MS/MS analysis so that a peak of precursor ions is sufficiently observed in the MS/MS spectrum. Therefore, for example, the spectrum creation unit 43 extracts the ion peak included in the mass window for each MS/MS spectrum having a different mass window, and estimates that a peak having the highest signal intensity is the peak of the precursor ion. For example, in the example of FIG. 4, since five peaks estimated to be precursor ions are obtained from MS/MS spectra corresponding to five mass windows, the five peaks are collected to create a pseudo MS spectrum. Of course, in a case where it is known from prior information or the like that a peak having the highest signal intensity among a plurality of ion peaks included in a certain mass window is not the peak of the precursor ion, the algorithm can be appropriately changed by selecting a peak having the next highest signal intensity. The pseudo MS spectrum may be created by other methods.

When the user performs an operation of moving the pointer 111 to the left and right by the input unit 5 in a state where the chromatogram and the spectrum are displayed on the graph display screen 100 as described above, the spectrum creation unit 43 updates each of the displayed MS spectrum and MS/MS spectrum in substantially real time according to the change in the retention time associated with the operation. That is, in a case where the painter 111 is moved by the operation of the user, the spectrum creation unit 43 calculates the retention time during which the pointer 111 is located during and after the movement front only the information of the movement of the pointer 111, that is, without requiring the other user's operation (clicking of a mouse, a determination (enter key input) input operation or the like), automatically creates the MS spectrum and the MS/MS spectrum corresponding to the retention time, and updates the display. Thus, for example, the user can visually and quickly (without delay) observe the temporal change of the MS spectrum and the temporal change of the MS/MS spectrum for a specific precursor ion having a parent-child relationship with the MS spectrum in the time around the retention time at which the chromatographic peak is observed.

Of course, not the MS spectrum and the MS/MS spectrum at the retention time designated by the user, but the change of the MS spectrum and the change of the MS/MS spectrum over the retention time range from a designated start time point to an end time point may be automatically displayed as a moving image.

Average processing and subtraction processing of MS spectra and/or MS/MS spectra in a parent-child relationship can be performed as follows.

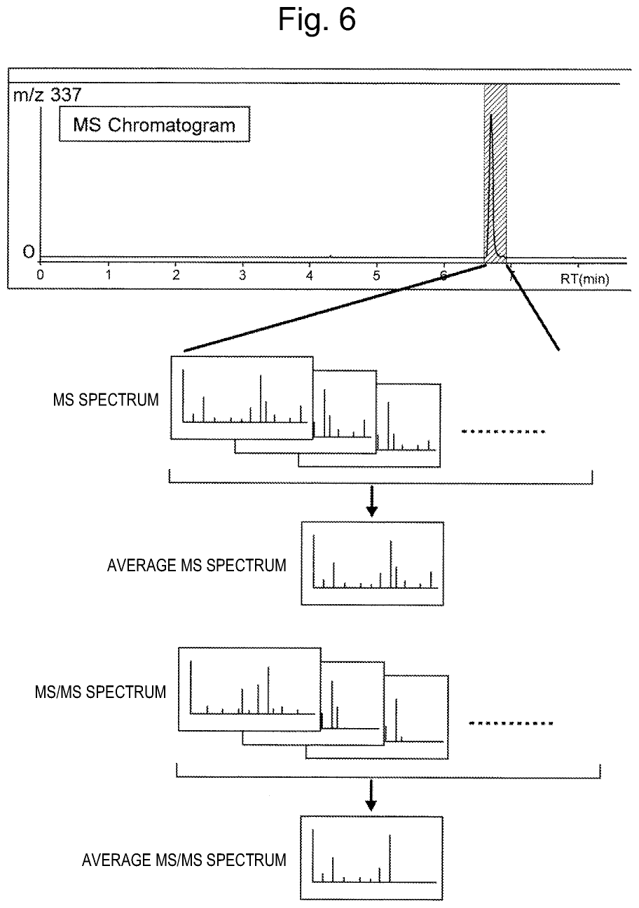

The user designates a desired retention time range on the extracted ion chromatogram displayed on the graph display screen 100. In the example of FIG. 6, the retention time range is designated such that one entire chromatographic peak is included.

The spectrum calculation unit 44 having received the designation of the retention time range via the input reception unit 46 acquires all the MS spectrum data corresponding to all the retention times included in the retention time range, adds all the MS spectrum data, and then normalizes the MS spectrum data. As a result, an average MS spectrum in which the signal intensity for each mass-to-charge ratio value is averaged for the retention time range is obtained. Furthermore, MS/MS spectrum data in which ions corresponding to all the retention times included in the same retention time range and having a mass-to-charge ratio of the extracted ion chromatogram or a plurality of ions included in a mass window to which the mass-to-charge ratio belongs are precursor ions is all acquired. Then, by normalizing after adding all of them, an average MS/MS spectrum in which the signal intensity for each mass-to-charge ratio value is averaged for the retention time range is obtained. The display processing unit 45 displays the average MS spectrum and the average MS/MS spectrum thus obtained.

At this time, for example, when the user changes the retention time range in the same manner as the movement of the pointer 111, the displayed average MS spectrum and average MS/MS spectrum may be updated following the change.

Moreover, when the user designates two retention time ranges on the extracted ion chromatogram and then instructs execution of subtraction, the spectrum calculation unit 44 obtains average MS spectra and average MS/MS spectra respectively corresponding to the two retention time ranges, and calculates a difference in signal intensity for each mass-to-charge ratio between the average MS spectra and between the average MS/MS spectra. Then, based on the calculation result, a difference MS spectrum and a difference MS/MS spectrum are created and displayed on the screen.

As described above, it is possible to visually observe the average or subtraction result of the MS spectrum and the MS/MS spectrum in the parent-child relationship.

In the above embodiment, the present invention is applied to an LC-MS analysis system, but the present invention can also be applied to a GC-MS analysis system. In the above embodiment, the mass spectrometry unit is a Q-TOF mass spectrometer, but may be other types of tandem mass spectrometer capable of the MS/MS analysis. A triple quadrupole mass spectrometer, an ion trap mass spectrometer, an ion trap time-of-flight mass spectrometer, and the like are examples of such a mass spectrometer.

In the LC-MS analysis system of the above embodiment, the data to be processed, that is, the data for which the graph is to be created is stored in the data storage unit 41, but as illustrated in FIG. 1, the data collected by the analysis device may be stored in another data management computer 7 connected via a communication line such as the Internet. Even in such a case, it is a matter of course that a system that can access such another computer can execute the display processing as described above.

The above-described embodiments and modification and examples are merely examples of the present invention, and it is obvious that modifications, corrections and additions appropriately made within the scope of the present invention are included in the claims of the present application.

### Various Modes

It is understood by those skilled in the art that the exemplary embodiments described above are specific examples of the following modes.

(Clause 1) One mode of a chromatograph mass spectrometry data processing method according to the present invention is a chromatograph mass spectrometry data processing method for processing data collected by a measurement unit including a mass spectrometry unit capable of MSⁿ analysis (n is an integer of 2 or more), and configured to temporally separate components in a sample by a chromatograph and repeatedly perform mass spectrometry on the separated sample, the chromatograph mass spectrometry data processing method including:
a chromatogram display processing step of creating a chromatogram at a specific mass-to-charge ratio based on the data collected by the measurement unit and displaying the chromatogram on a screen of a display unit;
a time designation step of designating a retention time according to an operation of a user on the displayed chromatogram; and
a spectrum display processing step of creating an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and displaying the MS spectrum and the MSⁿ spectrum on a same screen with the chromatogram,
wherein in the time designation step, the retention time is designated by an operation of moving a pointer displayed on the chromatogram, and
in the spectrum display processing step, as the pointer is moved, display of the MS spectrum and the MSⁿ spectrum is updated corresponding to each retention time during the movement of the pointer.

(Clause 6) One mode of a chromatograph mass spectrometer according to the present invention includes:
a measurement unit including a mass spectrometry unit capable of MSⁿ analysis to is an integer of 2 or more), and configured to temporally separate components in a sample by a chromatograph and repeatedly perform mass spectrometry on the separated sample;
a chromatogram display processing unit configured to create a chromatogram at a specific mass-to-charge ratio based on data collected by the measurement unit and display the chromatogram on a screen of a display unit;
a time designation unit configured to designate a retention time according to an operation of a user on the displayed chromatogram; and
a spectrum display processing unit configured to create an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and display the MS spectrum and the MSⁿ spectrum on a same screen with the chromatogram,
wherein the time designation unit is configured to designate a retention time by allowing a user to perform an operation to move a pointer displayed on the chromatogram, and
the spectrum display processing unit is configured to, as the pointer is moved, update display of the MS spectrum and the MSⁿ spectrum corresponding to each retention time during movement of the pointer.

(Clause 11) One mode of a chromatograph mass spectrometry data processing program according to the present invention is a chromatograph mass spectrometry data processing program that, using a computer, processes data collected by a measurement unit including a mass spectrometry unit capable of MSⁿ analysis (n is an integer of 2 or more), and configured to temporally separate components in a sample by a chromatograph and repeatedly perform mass spectrometry on the separated sample, the program causing the computer to operate as:
a chromatogram display processing function unit configured to create a chromatogram at a specific mass-to-charge ratio based on the data collected by the measurement unit and display the chromatogram on a screen of a display unit;
a time designation function unit configured to designate a retention time according to an operation of a user on the displayed chromatogram; and
a spectrum display processing function unit configured to create an MS spectrum corresponding to the designated retention time and a MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and display the MS spectrum and the MSⁿ spectrum on a same screen with the chromatogram,
wherein the time designation function unit is configured to designate a retention time by an operation of moving a pointer displayed on the chromatogram, and
the spectrum display processing function unit is configured to, as the pointer is moved, update display of the MS spectrum and the MSⁿ spectrum corresponding to each retention time during movement of the pointer.

According to one mode of the chromatograph mass spectrometry data processing method recited in Clause 1, the chromatograph mass spectrometer recited in Clause 6, and the chromatograph mass spectrometry data processing program recited in Clause 11, the user can visually and easily grasp the MS spectrum and the MS/MS spectrum in a parent-child relationship for each retention time. Furthermore, for example, the MS spectrum and the MSⁿ spectrum at the retention time can be immediately observed by simply specifying the retention time corresponding to the peak top on the extracted ion chromatogram and an arbitrary retention time in the vicinity of the specified retention time. Thereby, useful and accurate information for compound identification and quantification can be quickly obtained. Moreover, for example, the user can quickly observe the temporal change of the MS spectrum and the MSⁿ spectrum in the parent-child relationship on the screen in conjunction with each other only by moving the pointer near the retention time of interest on the extracted ion chromatogram. Thereby, the collected data can be analyzed in a more multifaceted manner, and useful and accurate information can be extracted for the identification and quantification of the compound.

(Clause 2) In the chromatograph mass spectrometry data processing method recited in Clause 1, in the time designation step, a range of a retention time range can be designated according to an operation of a user on the displayed chromatogram, and the method may further include a spectrum calculation step of acquiring an average spectrum by, averaging a plurality of the MS spectra and a plurality of the MS spectra corresponding to the designated range of the retention time based on the data collected by the measurement unit.

(Clause 7) In the chromatograph mass spectrometer recited in Clause 6, the time designation unit can designate a range of a retention time according to an operation by a user on the displayed chromatogram, and the chromatograph mass spectrometer may further include a spectrum calculation unit configured to acquire an average spectrum by averaging a plurality of the MS spectra and a plurality of the MSⁿ spectra corresponding to the designated range of the retention time based on the data collected by the measurement unit.

(Clause 12) In the chromatograph mass spectrometry data processing program recited in Clause 11, the time designation function unit can enable a user to designate a range of a retention time according to an operation on the displayed chromatogram, and the program may further cause the computer to operate as a spectrum calculation function unit configured to acquire an average spectrum by averaging a plurality of the MS spectra and a plurality of the MSⁿ spectra corresponding to the designated range of the retention time based on the data collected by the measurement unit.

According to the chromatograph mass spectrometry data processing method recited in Clause 2, the chromatograph mass spectrometer recited in Clause 7, or the chromatograph mass spectrometry data processing program recited in Clause 12, the user can simultaneously observe the average MS spectrum and the average MSⁿ spectrum corresponding to an appropriate range of the retention time on the screen. Thereby, the collected data can be analyzed in a more multifaceted manner, and useful and accurate information can be extracted for the identification and quantification of the compound.

(Clause 3) In the chromatograph mass spectrometry data processing method recited in Clause 2, in the time designation step, a plurality of the ranges of the retention time can be designated, and in the spectrum calculation step, subtraction may be performed between the plurality of MS spectra and/or between the plurality of MSⁿ spectra obtained by averaging in the plurality of designated ranges of the retention time.

(Clause 8) In the chromatograph mass spectrometer recited in Clause 7,
the time designation unit enables designation of a plurality of the ranges of the retention time, and the spectrum operation unit may be configured to perform subtraction between the plurality of MS spectra and/or between the plurality of MS spectra obtained by averaging in the plurality of designated ranges of the retention time.

(Clause 13) In the chromatograph mass spectrometry data processing program recited in Clause 12, the time designation function unit enables designation of a plurality of the ranges of the retention time, and the spectrum operation function unit may be configured to perform subtraction between the plurality of MS spectra and/or between the plurality of MSⁿ spectra obtained by averaging in the plurality of designated ranges of the retention time.

According to the chromatograph mass spectrometry data processing method recited in Clause 3, the chromatograph mass spectrometer recited in Clause 8, or the chromatograph mass spectrometry data processing program recited in Clause 13, for example, the user can remove the influence of a compound other than the target compound and simultaneously observe the average MS spectrum and the average MSⁿ spectrum having high purity for the target compound on the screen.

(Clause 4) In the chromatograph mass spectrometry data processing method recited in Clause 1, the data collected by the measurement unit may be obtained by data dependent analysis in the mass spectrometry unit.

(Clause 9) In the chromatograph mass spectrometer recited in Clause 6, the mass spectrometry unit may perform data dependent analysis, and the data collected by the measurement unit may be obtained by the data dependent analysis in the mass spectrometry unit.

(Clause 14) In the chromatograph mass spectrometry data processing program recited in Clause 11, the data collected by the measurement unit may be obtained by data dependent analysis in the mass spectrometry unit.

According to the chromatograph mass spectrometry data processing method recited in Clause 4, the chromatograph mass spectrometer recited in Clause 9, or the chromatograph mass spectrometry data processing program recited in Clause 14, the MS spectrum and the MSⁿ spectrum targeting one precursor ion observed in the MS spectrum can be simultaneously observed on the screen.

(Clause 5) In the chromatograph mass spectrometry data processing method recited in Clause 1 the data collected by the measurement unit may be obtained by data independent analysis in the mass spectrometry unit.

(Clause 10) in the chromatograph mass spectrometer recited in Clause 6, the mass spectrometry unit may perform data independent analysis, and the data collected by the measurement unit may be obtained by, the data independent analysis in the mass spectrometry unit.

(Clause 15) In the chromatograph mass spectrometry data processing program recited in Clause 11, the data collected by the measurement unit may be obtained by data independent analysis in the mass spectrometry unit.

According to the chromatograph mass spectrometry data processing method recited in Clause 5, the chromatograph mass spectrometer recited in Clause 10, or the chromatograph mass spectrometry data processing program recited in Clause 15, the MS spectrum, the MSⁿ spectrum corresponding to a predetermined mass window including ions that are targets of an extracted ion chromatogram, and the MS spectrum in which ions that are targets of the extracted ion chromatogram are observed can be simultaneously observed on a screen.

### REFERENCE SIGNS LIST

### 1 . . . Liquid Chromatograph Unit

### 10 . . . Mobile Phase Container

### 11 . . . Liquid Feeding Pump

### 12 . . . Injector

### 13 . . . Column

### 2 . . . Mass Spectrometry Unit

### 20 . . . Vacuum Chamber

### 201 . . . Ionization Chamber

### 202 . . . First Intermediate Vacuum Chamber

### 203 . . . Second Intermediate Vacuum Chamber

### 204 . . . First High Vacuum Chamber

### 205 . . . Second High Vacuum Chamber

### 21 . . . Electrospray Ionization (ESI) Probe

### 22 . . . Desolvation Tube

### 23, 25, 28, 29 . . . Ion Guide

### 24 . . . Skimmer

### 26 . . . Quadrupole Mass Filter

### 27 . . . Collision Cell

### 30 . . . Orthogonal Acceleration Unit

### 31 . . . Ion Flight Unit

### 32 . . . Ion Detector

### 4 . . . Control Processing Unit

### 40 . . . Analysis Control Unit

### 41 . . . Data Storage Unit

### 42 . . . Chromatogram Creation Unit

### 43 . . . Spectrum Creation Unit

### 44 . . . Spectrum Calculation Unit

### 45 . . . Display Processing Unit

### 46 . . . Input Reception Unit

### 5 . . . Input Unit

### 6 . . . Display Unit

### 7 . . . Data Management Computer

### 100 . . . Graph Display Screen 100

### 110 . . . Chromatogram Display Region

### 111 . . . Pointer

### 120 . . . MS Spectrum Display Region

### 130 . . . MS/MS Spectrum Display Region

1. A chromatograph mass spectrometry data processing method for processing data collected by a measurement unit configured to temporally separate components in a sample by a chromatograph and repeatedly perform mass spectrometry on the separated sample, the chromatograph mass spectrometry data processing method comprising:
a chromatogram display processing step of creating a chromatogram based on the data collected by the measurement unit and displaying the chromatogram on a screen of a display unit;
a time designation step of designating a retention time according to an operation of a user on the displayed chromatogram; and
a spectrum display processing step of creating a mass spectrum corresponding to the designated retention time based on the data collected by the measurement unit, and displaying the mass spectrum on a same screen with the chromatogram,
wherein in the time designation step, the retention time is designated by an operation of moving a pointer displayed on the chromatogram, and
in the spectrum display processing step, as the pointer is moved, display of the mass spectrum is updated corresponding to each retention time during the movement of the pointer.

2. The chromatograph mass spectrometry data processing method according to claim 1, wherein in the time designation step, a range of a retention time range can be designated according to an operation of a user on the displayed chromatogram,
further comprising a spectrum calculation step of acquiring an average spectrum by averaging a plurality of the mass spectra corresponding to the designated range of the retention time based on the data collected by the measurement unit.

3. The chromatograph mass spectrometry data processing method according to claim 2, wherein
in the time designation step, a plurality of the ranges of the retention time can be designated, and
in the spectrum calculation step, subtraction is performed between the plurality of average spectra obtained by averaging in the plurality of designated ranges of the retention time.

4. The chromatograph mass spectrometry data processing method according to claim 1, wherein the data collected by the measurement unit is obtained by data dependent analysis in the mass spectrometry unit.

5. The chromatograph mass spectrometry data processing method according to claim 1, wherein the data collected by the measurement unit is obtained by data independent analysis in the mass spectrometry unit.

6. A chromatograph mass spectrometer comprising:
a measurement unit configured to temporally separate components in a sample by a chromatograph and repeatedly perform mass spectrometry on the separated sample;
a chromatogram display processing unit configured to create a chromatogram based on data collected by the measurement unit and display the chromatogram on a display screen;
a time designation unit configured to designate a retention time according to an operation of a user on the displayed chromatogram; and
a spectrum display processing unit configured to create a mass spectrum corresponding to the designated retention time based on the data collected by the measurement unit, and display the mass spectrum on a same display screen with the chromatogram,
wherein the time designation unit is configured to designate a retention time by allowing a user to perform an operation to move a pointer displayed on the chromatogram, and
the spectrum display processing unit is configured to, as the pointer is moved, update display of the mass spectrum corresponding to each retention time during movement of the pointer.

7. The chromatograph mass spectrometer according to claim 6, wherein the time designation unit can designate a range of a retention time according to an operation by a user on the displayed chromatogram,
further comprising a spectrum calculation unit configured to acquire an average spectrum by averaging a plurality of the mass spectra corresponding to the designated range of the retention time based on the data collected by the measurement unit.

8. The chromatograph mass spectrometer according to claim 7, wherein
the time designation unit enables designation of a plurality of the ranges of the retention time, and
the spectrum operation unit is configured to perform subtraction between the plurality of average spectra obtained by averaging in the plurality of designated ranges of the retention time.

9. The chromatograph mass spectrometer according to claim 6, wherein the mass spectrometry unit performs data dependent analysis, and the data collected by the measurement unit is obtained by the data dependent analysis in the mass spectrometry unit.

10. The chromatograph mass spectrometer according to claim 6, wherein the mass spectrometry unit performs data independent analysis, and the data collected by the measurement unit is obtained by the data independent analysis in the mass spectrometry unit.

11. A non-transitory computer-readable recording medium storing a chromatograph mass spectrometry data processing program that, using a computer, processes data collected by a measurement unit configured to temporally separate components in a sample by a chromatograph and repeatedly perform mass spectrometry on the separated sample, the program causing the computer to operate as:
a chromatogram display processing function unit configured to create a chromatogram based on the data collected by the measurement unit and display the chromatogram on a display screen;
a time designation function unit configured to designate a retention time according to an operation of a user on the displayed chromatogram; and
a spectrum display processing function unit configured to create an masses spectrum corresponding to the designated retention time based on the data collected by the measurement unit, and display the mass spectrum on a same display screen with the chromatogram,
wherein the time designation function unit is configured to designate a retention time by an operation of moving a pointer displayed on the chromatogram, and
the spectrum display processing function unit is configured to, as the pointer is moved, update display of the mass spectrum corresponding to each retention time during movement of the pointer.

12-15. (canceled)

16. The chromatograph mass spectrometry data processing method according to claim 1, wherein the chromatogram is a chromatogram at a specific mass-to-charge ratio.

17. The chromatograph mass spectrometry data processing method according to claim 1, wherein
the measurement unit includes a mass spectrometry unit capable of MSⁿ analysis (n is an integer of 2 or more), and
in the spectrum display processing step, an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, are created as the mass spectrum based on the data collected by the measurement unit, and the MS spectrum and the MSⁿ spectrum are displayed on a same screen with the chromatogram.

18. The chromatograph mass spectrometry data processing method according to claim 17, wherein in the spectrum display processing step, as the pointer is moved, display of the MS spectrum and the MSⁿ spectrum is updated corresponding to each retention time during the movement of the pointer.

19. The chromatograph mass spectrometer according to claim 6, wherein the chromatogram is a chromatogram at a specific mass-to-charge ratio.

20. The chromatograph mass spectrometer according to claim 6, wherein
the measurement unit includes a mass spectrometry unit capable of MSⁿ analysis (n is an integer of 2 or more), and
the spectrum display processing unit is configured to create, as the mass spectrum, an MS spectrum corresponding to the designated retention time and an MSⁿ spectrum that is an MSⁿ analysis result corresponding to the designated retention time, in which ions having a mass-to-charge ratio of a peak appearing in the MS spectrum or ions included in a mass-to-charge ratio range to which the mass-to-charge ratio belongs are precursor ions, based on the data collected by the measurement unit, and display the MS spectrum and the MSⁿ spectrum on a same display screen with the chromatogram.

21. The chromatograph mass spectrometer according to claim 20, wherein the spectrum display processing unit is configured to, as the pointer is moved, update display of the MS spectrum and the MSⁿ spectrum corresponding to each retention time during movement of the pointer.
